(19) United States
(12) Patent Application Publication
(10) Pub. No.: US 2003/0005132 A1
(43) Pub. Date: Jan. 2, 2003

(54) Distributed service creation and distribution

(75) Inventors: Thinh D. Nguyen, Kanata (CA); Ashutosh Bagchi, Ottawa (CA)

Correspondence Address: SMART AND BIGGAR, 438 UNIVERSITY AVENUE, SUITE 1500 BOX 111, TORONTO, ON, M5G2K8, CA

(73) Assignee: NORTEL NETWORKS LIMITED

(21) Appl. No.: 09/855,518

(22) Filed: May 16, 2001

(51) Int. Cl. G06F 15/16; G06F 15/173

(52) U.S. Cl. 709/229; 709/225

(57) ABSTRACT

A service provider is enabled to easily create and distribute data network services over a wide area data network such as the Internet. Powerful distributed computing technology and popular standards like Domain Name Service (DNS) and Extensible Markup Language (XML) may be leveraged to provide a scalable and secure service infrastructure. A directory service utility maintains a registry of service providers of data network services. In response to receiving a query for a particular service, the directory service utility identifies a provider of the particular service to the network connected device. The network connected device may then contact the service provider directly and receive an application (i.e., an executable file) for accessing the particular data network service. Distributed computing features are used to reduce the need for widespread distribution of additional protocols when new services are created. This increases service creation, reduces time-to-market of new services and minimizes services management and maintenance requirements.

### FIELD OF THE INVENTION

The present invention relates to creation and distribution of services over data networks and, in particular, to coordinating access to these services and accessing these services.

### BACKGROUND OF THE INVENTION

Today, most services available on the Internet are based on a client/server architecture, in which both client and server must speak the same protocol. To implement a new service with a protocol based architecture, a time delay is inherent for finalization of the protocol by a standards organization, as well as for adoption of the service by a community. This finalization and adoption can dramatically increase the time-to-market for the technology. Also, new services often require enhancements to existing protocols or a completely new set of protocols. This requirement also affects the time-to-market of the new services. Furthermore, the deployment of new services requires that management and maintenance efforts increase, since global changes to already deployed services are necessitated. In a fast growing and changing service provision environment like the Internet, the service creator/provider may realize a competitive advantage by finding a way around the client/server model.

Time-to-market, management effort required, maintenance effort required, scalability and security are the main criteria in designing and implementing a service provision infrastructure. Quite often, it is difficult to achieve a desirable solution without considering a trade-off between these criteria.

With the increasing trend of Peer-to-Peer networking and internet services moving beyond simply the delivery of HTML documents, there is a need for a new service infrastructure.

One solution, proposed by Sun Microsystems of Palo Alto, Calif., is called Jini™ network technology. In a system using Jini™ network technology, a given server registers with a look-up server by transferring to the look-up server a Java™ object corresponding to each of the capabilities of the given server. When an end user indicates to the look-up server a need for one of the services offered by the given server, the look-up server transfers a Java™ object, which corresponds to the needed one of the services, to the end user. The end user may then use that object to obtain the service from the given server. A number of look-up servers may be inter-connected to form a Jini™ federation. However, Jini™ federations have limitations in terms of scalability and security. Further, it has been noted that technical, marketing and licensing problems all have contributed to the lack of a healthy developer community not just for Jini™, but also for Java™ itself. Other emerging networking protocols and architectures, such as Bluetooth™, Universal Plug and Play and .NET™ from Microsoft, TSpaces from IBM, CORBA from the Object Management Group, Service Location Protocol from the Internet Engineering Task Force (IETF) and Salutation from the Salutation Consortium, indicate the importance of the need for a new service infrastructure. However, drawbacks associated with these protocols and architectures, including a lack of scalability and security or reliance on particular communication or implementation technology, remain and further work is required.

### SUMMARY OF THE INVENTION

The present invention enables a service provider to create and easily distribute data network services over a wide area data network such as the Internet. A directory service utility maintains a registry of service providers of data network services. In response to receiving a query for a particular service, the directory service utility identifies a provider of the particular service to the network connected device. The network connected device may then contact the service provider directly and receive an application (i.e., an executable file) for accessing the particular data network service.

Advantageously, when the herein proposed architecture is used to deploy data network services, time-to-market, management and maintenance are reduced while scalability and security are increased without trading off benefits for detriments in the above criteria.

In accordance with an aspect of the present invention there is provided a method of coordinating access to a data network service. The method includes maintaining a registry of a plurality of service providers, receiving a query for a requested data network service from a source, the query including required attributes of the requested data network service, searching the registry to determine whether a given one of the plurality of service providers in the registry can provide the requested data network service having the required attributes and, if the given one of the plurality of service providers in the registry can provide the requested data network service having the required attributes, sending information identifying the given one of the plurality of service providers to the source of the query. In a further aspect of the present invention, there is provided a directory service utility (DSU) for carrying out this method. In a further aspect of the present invention, there is provided a software medium that permits a general purpose computer to carry out this method.

In accordance with another aspect of the present invention there is provided a method of coordinating access to a data network service at a first directory service utility situated in a local service cluster. The method includes maintaining a registry of a plurality of service providers, receiving a propagated query for a requested data network service from a second directory service utility situated in a remote service cluster, where the propagated query includes a source of an initial query and required attributes of the requested data network service and searching the registry to determine whether a given one of the plurality of service providers in the registry can provide the requested data network service having the required attributes. If the given one of the plurality of service providers in the registry can provide the requested data network service having the required attributes, the method further includes extracting the source of the initial query from the propagated query and sending information identifying the given service provider to the source of the initial query.

In accordance with a further aspect of the present invention there is provided a method of registering a service provider. The method includes receiving a data network address for the service provider, receiving, from the service provider, attributes of a service provided by the service provider, where the attributes are expressed in Extensible Markup Language format, and adding the service provider to a registry of service providers.

In accordance with an even further aspect of the present invention there is provided, at a service provider, a method of registering with a directory service utility. The method includes multicasting a message indicating a requirement for a directory service utility, receiving a reply from a given directory service utility and sending a service description to the given directory service utility.

In accordance with a still further aspect of the present invention there is provided a method of building network relationships at a first directory service utility in communication with at least one other directory service utility. The method includes selecting one the directory service utility from the at least one other directory service utility as a selected directory service utility, assigning the selected directory service utility a parent directory service utility designation and indicating the parent directory service utility designation to the selected directory service utility.

In accordance with an even further aspect of the present invention there is provided a method of service information propagation at a first directory service utility. The method includes creating a summary of information about at least one service provider registered with the directory service utility and sending the summary to a second directory service utility.

In accordance with an even further aspect of the present invention there is provided a method of coordinating access to a data network service. The method includes maintaining a registry of a plurality of service providers, receiving a query for a requested data network service from a source, the query including required attributes of the requested data network service, and searching the registry to determine whether a given one of the plurality of service providers in the registry can provide the requested data network service having the required attributes. If none of the plurality of service providers in the registry can provide the requested data network service having the required attributes, the method further includes consulting a summary of services available at service providers registered with at least one remote directory service utility, determining that the requested data network service is available from a service provider registered with a particular remote directory service utility and sending a propagated query to the particular remote directory service utility, where the propagated query is based on the query for the requested data network service.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate example embodiments of this invention:

FIG. 1 illustrates a communications network for use with an embodiment of the present invention;

FIG. 2 illustrates a service cluster in the communications network of FIG. 1;

FIG. 3 illustrates a service community from the service cluster of FIG. 2;

FIG. 4 illustrates a directory service utility according to an embodiment of the present invention;

FIG. 5 illustrates the steps of a method of registering provision of a service with a directory service utility according to an embodiment of the present invention;

FIG. 6 illustrates the steps of a method of registering a service provider according to an embodiment of the present invention;

FIG. 7 illustrates a first exemplary communications network for use with an embodiment of the present invention;

FIG. 8 illustrates a second exemplary communications network for use with an embodiment of the present invention;

FIG. 9 illustrates the steps of a method of accessing a data network service according to an embodiment of the present invention;

FIG. 10 illustrates the steps of a method of data network service coordination according to an embodiment of the present invention;

FIG. 11 illustrates the steps of a method of assisting data network service coordination according to an embodiment of the present invention; and

FIG. 12 illustrates a network relationship between service communities in the service cluster of FIG. 2.

### DETAILED DESCRIPTION

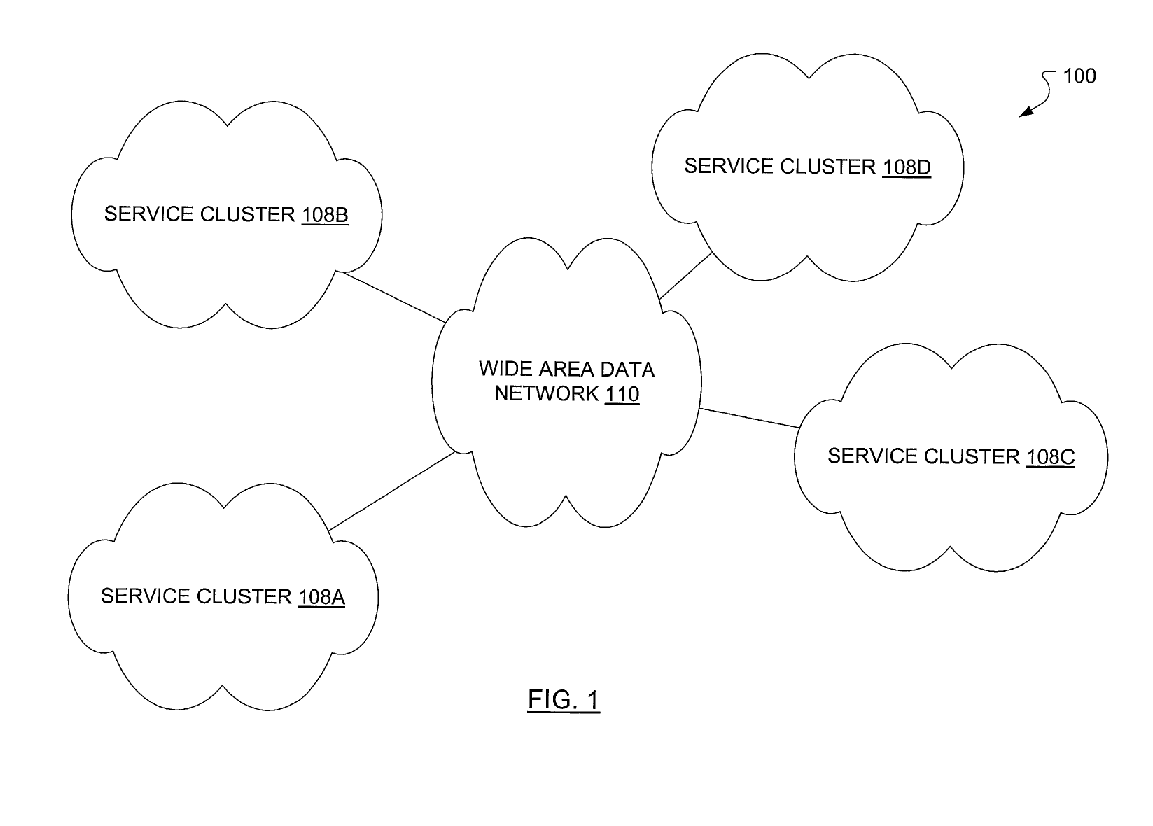

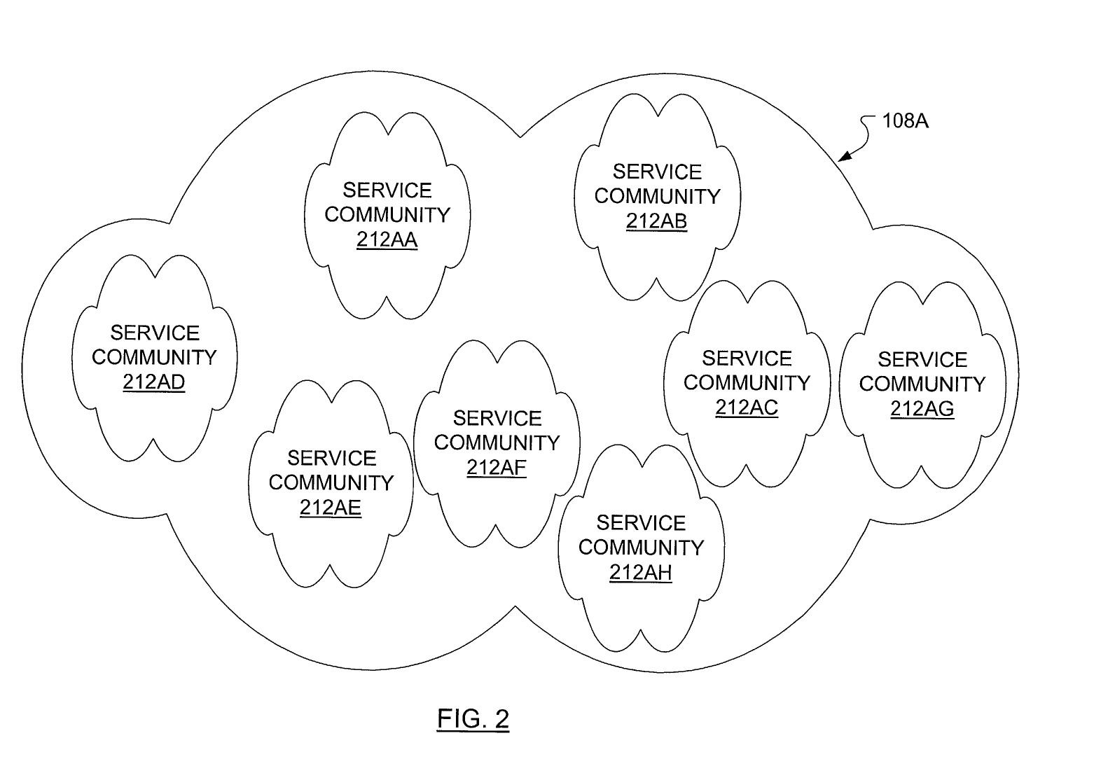

FIG. 1 illustrates a communications network 100 including a wide area data network 110 which connects a number of service clusters 108A, 108B, 108C, 108D (referred to collectively or individually as 108) to each other. A particular service cluster 108A is illustrated in FIG. 2 and is shown to include a cluster of service communities 212AA, 212AB, 212AC, 212AD, 212AE, 212AF, 212AG, 212AH (referred to collectively or individually as 212).

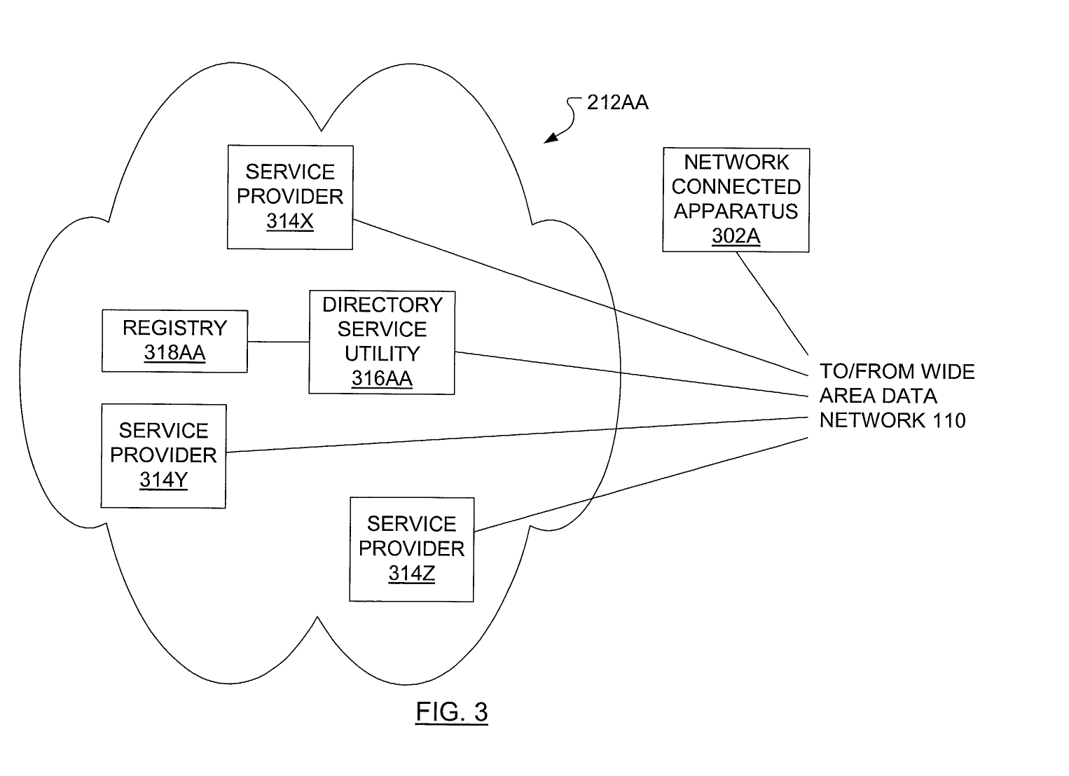

With reference to FIG. 3, a particular service community 212AA in this cluster includes a first service provider 314X, a second service provider 314Y and a third service provider 314Z (referred to collectively or individually as 314) for providing various data network services and a directory service utility 316AA (referred to generically as 316). The directory service utility 316AA maintains a registry 318AA of service providers 314.

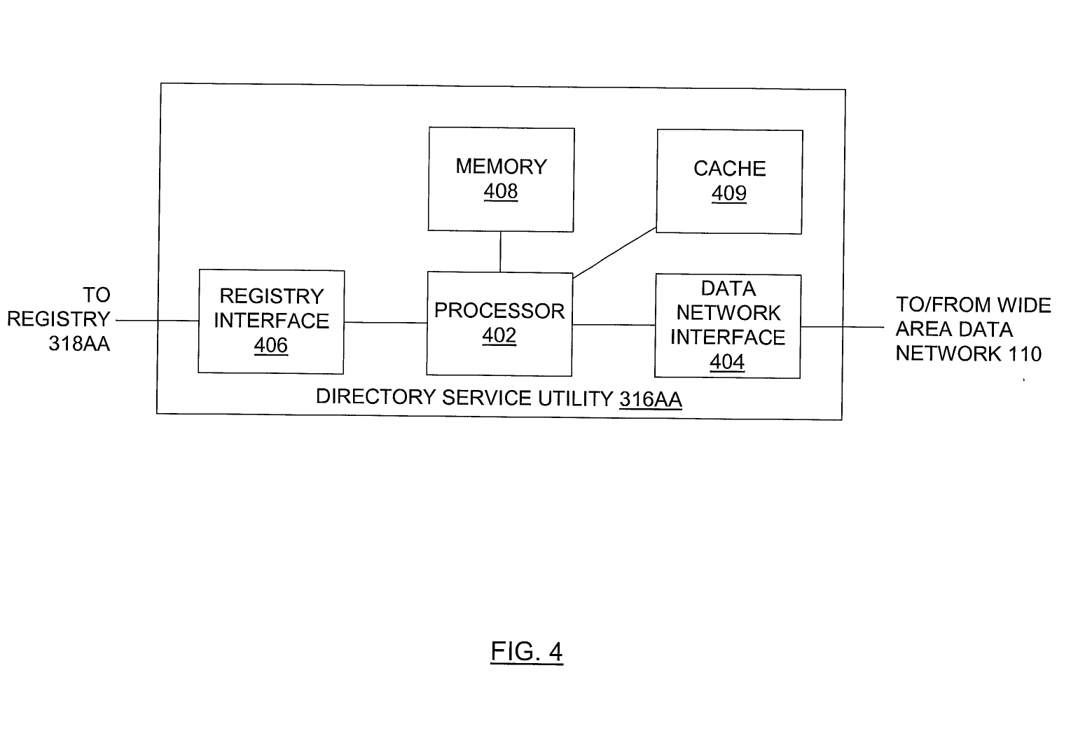

The directory service utility 316AA is illustrated in more detail in FIG. 4. The directory service utility 316AA includes a central processor 402 communicatively connected to a data network interface 404, a registry interface 406, a memory 408 and a cache 409.

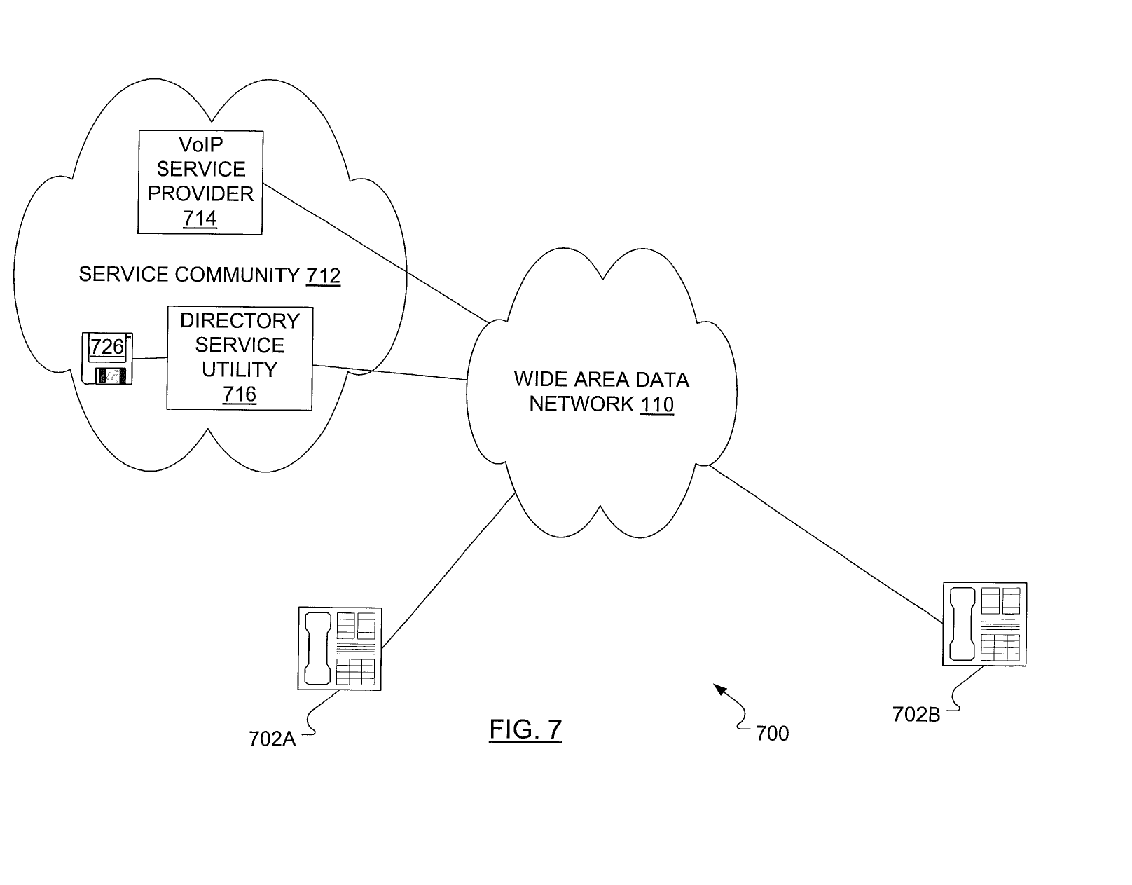

A first exemplary communications network 700 is illustrated in FIG. 7. Included in this first exemplary communications network 700 is a local telephone station apparatus 702A and a remote telephone station apparatus 702B. Each telephone station apparatus 702A, 702B connects to the wide area data network 110. Also connected to the wide area data network 110, is a first directory service utility (DSU) 716 and a first VoIP service provider 714, both of which belong to a first service community 712.

A processor in the first directory service utility 716 may be loaded with data network service access coordination software for executing a method exemplary of this invention from a software medium 726, which may be a disk, a tape, a chip or a random access memory containing a file downloaded from a remote source.

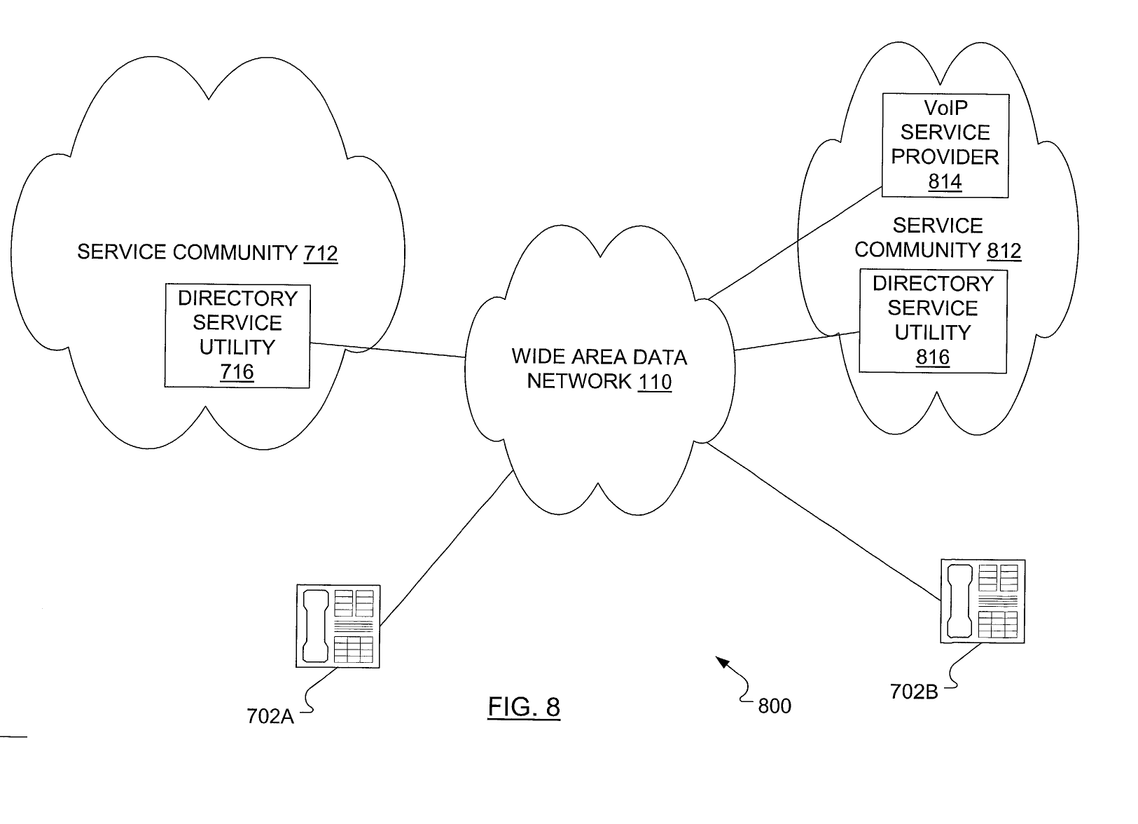

A second exemplary communications network 800 is illustrated in FIG. 8. Included in this second exemplary communications network 800 is the local telephone station apparatus 702A and the remote telephone station apparatus 702B. Also connected to the wide area data network 110, is the first directory service utility 716 as part of the first service community 712. A remote service community 812 includes a second directory service utility 816 and a remote VoIP service provider 814, both connected to the wide area data network 110.

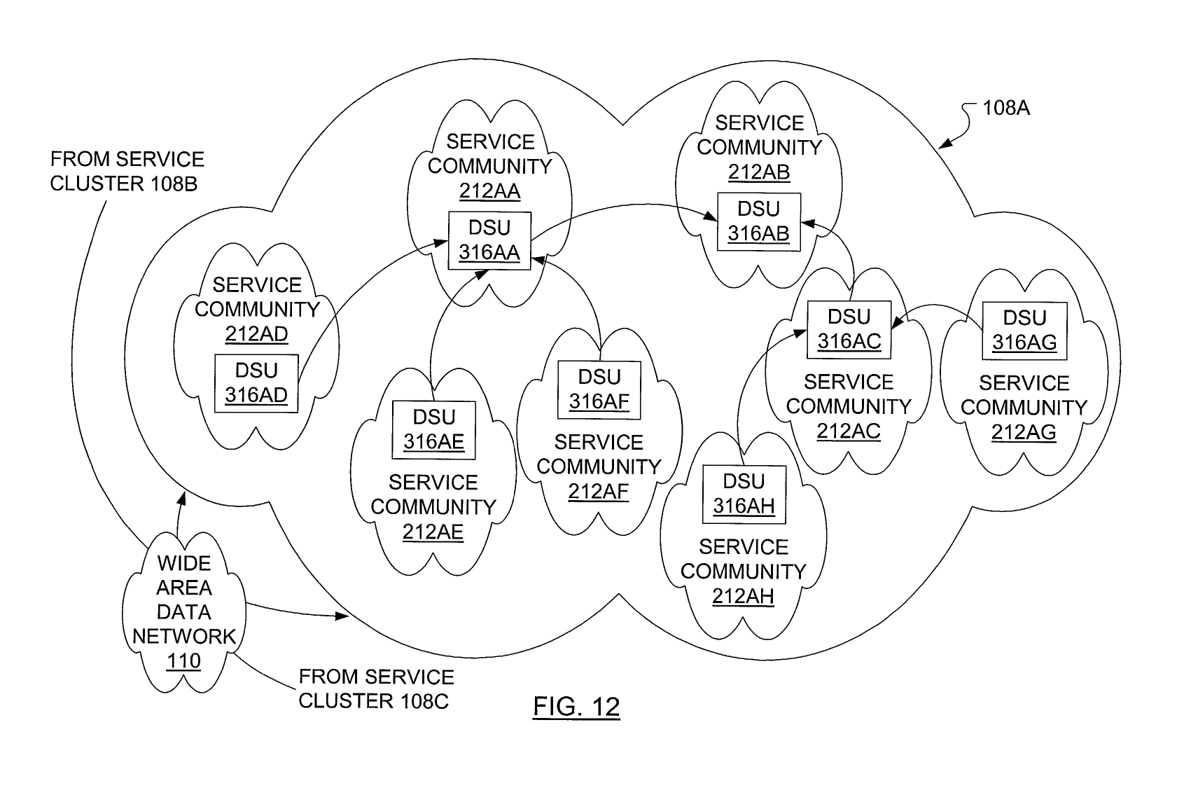

With reference to FIG. 12, the particular service cluster 108A of FIG. 2 is shown to include a respective directory service utility 316AA, 316AB, 316AC, 316AD, 316AE, 316AF, 316AG, 316AH (referred to collectively or individually as 316) corresponding to each service community 212. The directory service utility 316AA in a particular service community 212AA is aware of the presence of other service communities 212 in the service cluster 108A. In accordance with an embodiment of the present invention, the service communities 212 in the service cluster 108A form a hierarchical relationship among themselves through communication between the directory service utilities 316. For example, formation of such a hierarchical relationship may involve the service community 212AA assuming the responsibility of being the parent of three child service communities 212AD, 212AE and 212AF, and, itself, becoming a child of another service community 212AB. In this example, the service community 212AB has responsibility over two child service communities 212AA and 212AC. The service community 212AB does not have a parent and is therefore is called the “root” of service cluster 108A. Just as hierarchical relationships may be built between service communities, so may hierarchical relationships be built between service clusters. As shown in FIG. 12, communication may arrive at the service cluster 108A from other (child) service clusters 108B and 108C.

In accordance with the present invention, the relationship among service communities 212 are dynamically built and managed with minimal or nonexistent administrative interference. This helps in achieving automatic fault tolerance in the network of service communities 212. A similar relationship may exist among other service clusters 108. Collectively, these relationships may be called “network relationships”.

The present invention enables a service provider to create and easily distribute data network services over a wide area data network such as the Internet. Powerful distributed computing technology and popular standards like Domain Name Service (DNS) and Extensible Markup Language (XML) may be leveraged to provide a scalable and secure service infrastructure. The distributed computing features of the present invention reduce the need for widespread distribution of additional protocols when new services are created. For new services created by the service provider, this reduces time-to-market and minimizes services management and maintenance requirements. By using the well understood Internet protocols, the present invention can, for instance, integrate well into the current Internet environment.

A key factor in reducing the time-to-market for new services is the elimination of the dependency on specific protocols of an implementation of a new service provision system for these services. As will be described herein, this dependency may be eliminated through the use of a higher level of abstraction, without a corresponding degradation in the performance of the service provision system. Elimination of dependency on specific protocols relieves a service creator from the burden of dealing with standard protocols directly and enables the service creator to concentrate on application programming interfaces (APIs) for the new services. The herein proposed architecture provides the service creator with a facility to describe those services flexibly using a structured format, such as XML.

By using distributed computing technology, the cluster 108 of service communities 212 may be built in a scalable way. Each service community 212 in the cluster 108 comprises a set of local service providers 314 and a directory service utility 316 to periodically publish information about those service providers 314 within the service community and to other service communities 212 using a herein proposed service information propagation method, while minimizing use of network bandwidth. The directory service utility 316 allows local service providers 314 to be added and/or withdrawn dynamically with minimal or nonexistent management.

From the point of view of a user (i.e., a consumer of a data network service), obtaining a particular service, either from a local service provider or a remote service provider, is simply a matter of instructing the user's network-connected device to send a query to a local directory service utility 316 for the particular service. If the local directory service utility 316 has a registry entry for the particular service, a service provider 314 is selected from those listed in the registry 318 and the location (e.g., network address) of the service provider 314 is identified to the user's network-connected device. If the local directory service utility 316 does not have a registry entry for the particular service, the directory service utility 316 may use a “query propagation” mechanism to locate a service provider 314 for the particular service.

As part of such a query propagation mechanism, a query for the particular service is propagated to other directory service utilities. Once a remote directory service utility with a registry entry for the particular service receives the propagated query, the remote directory service utility may select a service provider from those listed in the registry and identify the selected service provider to the user's network-connected device. The propagated query may be described using the same standard structure described earlier (i.e., XML). As will be apparent to a person skilled in the art, standard, encryption-based, secure communications may be supported, such as service querying, transport and registration.

With reference to FIG. 3, each local service provider 314 registers with the local directory service utility 316AA. By way of this registration process, the local service provider 314 informs the local directory service utility 316AA of the service available from the respective local service provider 314. The local directory service utility 316AA updates the registry 318AA to reflect any changes received from the local service providers 314.

As well as receiving notice of services available from local service providers 314, the local directory service utility 316AA may also receive notice of services available from remote service providers. The hierarchical network relationship between service communities 212, described in conjunction with FIG. 12, may be particularly useful in the distribution of information regarding services available from remote service providers 314. This distribution of information may be called “service information propagation”.

In an exemplary service information propagation method, the directory service utility 316AA in the particular service community 212AA periodically sends a summary of XML-formatted descriptions of currently registered service providers to its parent directory service utility 316AB in its parent remote service community 212AB. Upon receiving a summary, a parent DSU may save a copy of the summary in memory and then forward the summary to its parent. Alternatively, upon receiving a summary from a child DSU, the parent DSU may prepare an aggregate summary of both the descriptions of service providers currently registered at the parent DSU along with summaries received to date from child DSUs and transmit the aggregate summary upwards in the hierarchy. As will be apparent to a person skilled in the art, it would be useful for each summary to identify the DSU to which a particular summary applies.

To conserve resources and promote scalability, the service information propagation method may use well known techniques, such as “hashing” and “bloom filtering” for creating a summary of the service descriptions before sending the summary to a directory service utility 316 in a parent service community 212.

The network connected apparatus 302A, having a requirement for a particular service, sends a query to the local directory service utility 316AA requesting the particular service. If the requested service is available locally (say, at the first service provider 314X), the local directory service utility 316AA responds to the network connected apparatus 302A indicating the address of the local service provider 314 (in this case, the first service provider 314X) that serves the requested service.

If the requested service is not available locally, the local directory service utility 316AA may send a propagated query to a remote DSU. The propagated query may be efficiently propagated based on the relationship among the service communities 212. For instance, by reviewing the summaries received from child DSUs, the local directory service utility 316AA may determine the location of a remote DSU that, according to a received summary, appears to have a service provider registered for this requested service. Although there is the possibility of the summary being out-of-date, in most cases, the result will be the location of an appropriate service provider.

However, if a suitable remote DSU to which to send a propagated query, may not be determined through a review of the summaries received from child DSUs, a propagated query may be sent to the parent DSU. The parent DSU, presumably, has received a greater number of summaries. Essentially, the propagated query progresses up the hierarchy until a parent DSU that has a summary, from a given child DSU, indicating that the requested service is available, receives the propagated query. The propagated query is then sent to the given child DSU. The given child DSU may then provide the identity of a remote service provider to the network connected apparatus 302A.

There exist a number of reasons why a propagated query might fail to result in a service provider's location being provided to the network connected apparatus 302A. If an upward progressing propagated query reaches the DSU in the root service community of a service cluster without having led to a communication from a DSU to the network connected apparatus 302A, the propagated query may be terminated. As described hereinbefore, the DSU in the root service community of a service cluster does not have a parent to which to forward a propagated query. A root directory service utility that has been established for a significant length of time should have a summary of services available throughout the entire service cluster. Accordingly, if a service is not found by such a root directory service utility, it may be assumed that the service is unavailable in the service cluster. Alternatively, upon reaching a root of a given service cluster, a propagated query may be sent to the root of a parent service cluster.

Additionally, a user can control the propagation of a query by specifying a maximum “number of hops” parameter in a query, also known as a “Time to Live (TTL)” parameter. If the number of hops taken by a propagated query exceeds the specified maximum number of hops, the propagated query may be terminated. Thus, a propagated query may be terminated before reaching the root.

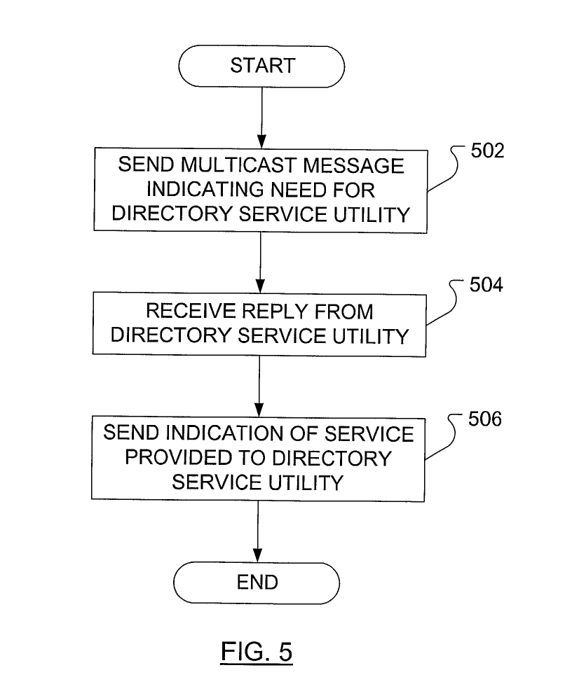

Steps of a typical registration process are illustrated in FIG. 5 from the point of view of a service provider 314. In order to register with a directory service utility 316, the service provider 314 need not initially be aware of the network address for the local directory service utility 316AA. A message may be multicast (step 502) from the service provider 314 indicating a requirement for a directory service utility 316 until a reply is received (step 504) from a directory service utility 316. After the service provider 314 knows the address of the directory service utility 316, the service provider 314 may send a description of the service provided to the directory service utility 316 (step 506) along with a request to be registered with the directory service utility 316.

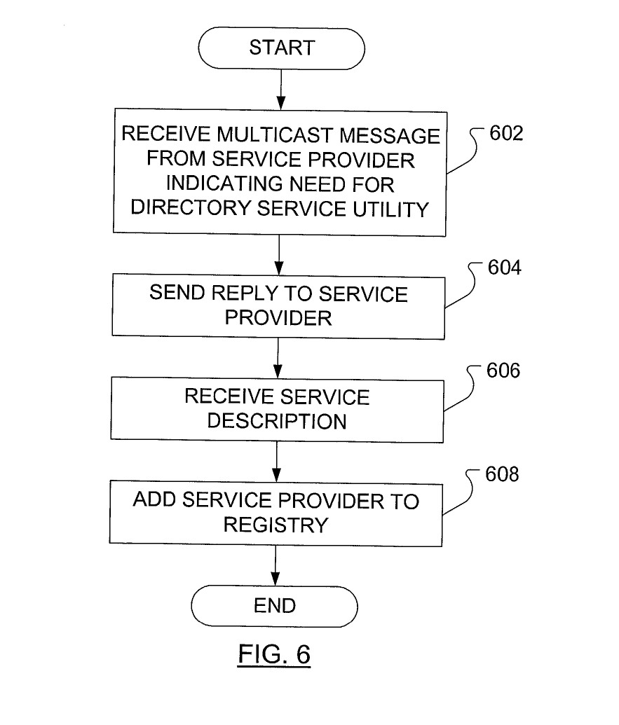

Steps of a typical registration process are illustrated in FIG. 6 from the point of view of the directory service utility 316. The process may begin with a multicast message being received (step 602) from a service provider 314. This receipt triggers the generation of a reply that is sent to the service provider 314 (step 604). Once the service provider 314 is aware of the address of the directory service utility 316, the service provider 314 sends a service description that is received (step 606) by the directory service utility 316 and added to the registry (step 608).

A simple XML representation of a description of a service provided by a service provider follows, where the service provider is a printer and the service is printing.

<?xml version=“1.0”?>
<PRINTER>

<NAME>HP 5M IN PROTONET LAB</NAME>
<LOCATION>

<BUILDING>CARLING LAB 5</BUILDING>
<ROOM>443</ROOM>
<FLOOR>2</FLOOR>

</LOCATION>
<COLOR>NO</COLOR>
<DUPLEX>YES</DUPLEX>
<RESOLUTION>600</RESOLUTION>
<MODEL>HP 5M</MODEL>
<LOGFILE>/var/log/lpd-errs</LOGFILE>
<SPOOLDIRECTORY>/var/spool/lpd/hp5mp443</
SPOOLDIRECTORY>

</PRINTER>

The above service description contains some key information about the service. The service description identifies the type of service such as “printer”, “scanner”, “spellchecker”, etc. The service description may also have other relevant information, such as “location”, “manufacturer”, “name” and other functional attributes such as “resolution”, etc., for a printer. The service provider can put as many attributes as necessary to describe the service reasonably well. Each attribute may have sub-attributes. In the above example, “location” has three sub-attributes, namely “building”, “room” and “floor”. A typical query contains required attributes of the requested service. When all the attributes required in a query are found in a service description and the values match, it may be said that the service description matches the query.

The registration of a particular service provider 314Y may be maintained through a lease granted by the directory service utility 316AA. The lease is periodically renewed by the particular service provider 314Y during its lifetime. When the particular service provider 314Y crashes or is taken out of commission, the particular service provider 314Y fails to renew the lease and the directory service utility 316AA removes the particular service provider 314Y from the registry 318AA. Additionally, given that the list of registered service providers will change over time, a DSU may periodically send updated register summaries to its parent.

Where a service provider 314 is aware of an address for a directory service utility 316, perhaps from a previous registration process, a requirement message need not be multicast to initiate registration.

It is assumed above that the network connected apparatus 302A is aware of the address of a directory service utility 316 to which to send a query for a data network service. Such may not always be the case. In a manner similar to the case wherein a service provider 314 is unaware of an address of a directory service utility 316 with which to register, the network connected apparatus 302A may choose to multicast a query indicating a requirement for a directory service utility. Information about the directory service utility 316 that responds to the multicast query may be saved at the network connected apparatus 302A so that future queries may be sent to the directory service utility 316 directly.

A first exemplary query follows, where the service requested is a printer and certain attributes (name, need for color) are associated with the query:

<?xml version=“1.0”?>

<PRINTER>

<NAME>HP 5M IN PROTONET LAB</NAME>

<COLOR>NO</COLOR>

</PRINTER>

A second exemplary query follows, where the service requested is a printer and certain attributes (location, need for duplex printing) are associated with the query:

<?xml version=“1.0”?>
<PRINTER>

<LOCATION>

<FLOOR>2</FLOOR>

</LOCATION>
<DUPLEX>YES</DUPLEX>

</PRINTER>

A third exemplary query follows, where the service requested is a printer and certain attributes (location, need for 600 dpi printing) are associated with the query:

<?xml version=“1.0”?>
<PRINTER>

<LOCATION>

<BUILDING>CARLING LAB 5</BUILDING>

</LOCATION>
<RESOLUTION>600</RESOLUTION>

</PRINTER>

In a simple example of the present invention in operation, the service in question is babysitting. Each babysitter in a babysitting service cluster registers with a directory service utility, which, in this case, may be more familiarly known as a babysitting agency. A user of the present invention sends a query to the babysitting agency indicating a need for the babysitting service. The babysitting agency responds to the query with a telephone number of a babysitter (a service provider) and the delivery of the service can then be arranged between the babysitter and the (potential) user of the babysitting service.

In a further example, illustrated in conjunction with FIG. 7, a user at the local telephone station apparatus 702A, which may be, for instance, an i2004 Internet Telephone from Nortel Networks of Montreal, Canada, wishes to place a call to the remote telephone station apparatus 702B. The user may have a preference for the call to use the wide area data network 110. Where the wide area data network 110 is the Internet, the call may be a Voice over Internet Protocol (VoIP) call.

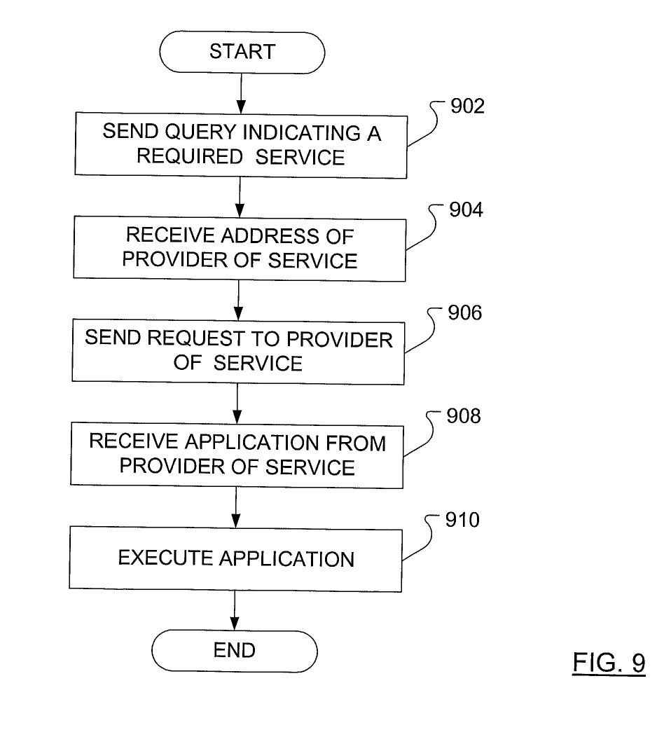

The local telephone station apparatus 702A can execute an application that allows the local telephone station apparatus 702A to perform a method exemplary of the present invention. Steps of such a method are illustrated in FIG. 9. The local telephone station apparatus 702A may not have access to a software load that provides the capability to perform a VoIP call. Consequently, the local telephone station apparatus 702A may send a query (step 902) to the first directory service utility 716, in the first service community 712, for a VoIP service provider. The first directory service utility 716 may send a response to the query indicating the address of the first VoIP service provider 714. The local telephone station apparatus 702A receives this response (step 904) and sends a request (step 906), for the VoIP service, to the first VoIP service provider 714. In response to the request for VoIP service, the first VoIP service provider 714 sends the VoIP application to the local telephone station apparatus 702A where the application is received (step 908) and executed (step 910), allowing the call to proceed.

Notably, there exist multiple protocols for use in the setup, maintenance and tear down of a VoIP call. Example protocols include a protocol specified by ITU-T Recommendation H.323, “Packet-Based Multimedia Communication Systems,” and the Session Initiation Protocol (SIP) discussed in IETF Request for Comments (RFC) 2543. If, as is the case with prior art devices, the local telephone station apparatus 702A was pre-loaded with an application that was designed to use either the H.323 protocol or SIP and a new standard for VoIP call was defined, an administrator of the local telephone station apparatus 702A would be required to update the software load on the local telephone station apparatus 702A and every other VoIP device for which the administrator has responsibility. In the case of a VoIP device using the present invention, when the VoIP standard changes, the application at the VoIP service provider 714 can be changed. Subsequently, when VoIP devices request VoIP services, the VoIP devices are provided with an up-to-date application using the new protocol.

Additionally, consider a scenario wherein, within a particular service community, there are service providers that provide services based on differing protocols. These protocols are likely to have inherent advantages and disadvantages. The selection of a service provider at the directory service utility may, therefore, be based on the manner in which information that is provided as part of the query received from a particular device maps to the various advantages and disadvantages of the protocols associated with the applications provided by the various service providers.

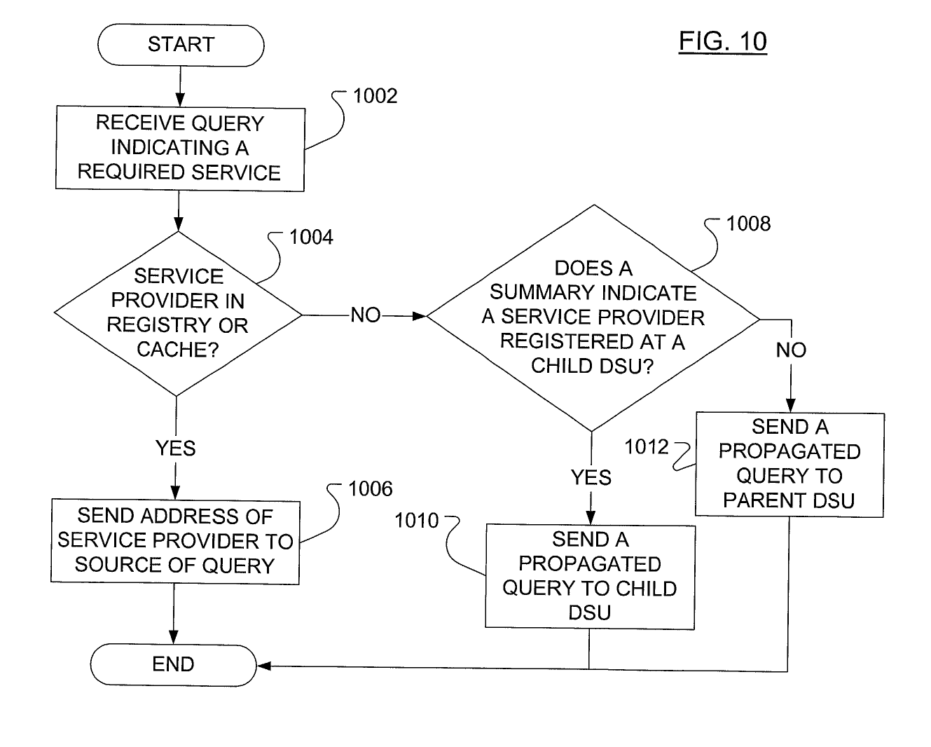

The steps of a method exemplary of an embodiment of the present invention are shown in FIG. 10 from the perspective of the first directory service utility 716. Initially, the first directory service utility 716 receives a query (step 1002) from a network connected device, such as the local telephone station apparatus 702A. The first directory service utility 716 then consults its registry to find a service provider for the requested service (step 1004). If a service provider is found, the address (or other locating information) of that service provider is sent to the source of the query (step 1006). Where more than one service provider is found, one service provider is selected and the address of the selected service provider is sent to the source of the query (step 1006). As detailed hereinafter, before consults its registry, the first directory service utility 716 may consult its cache to check if any information about a service provider for the required service exists in the cache as a result of a previous query. If it exists, the information is sent to the telephone station 702A (step 1006). If there is no relevant information in either the cache or the registry, summaries of services available in child, and other hierarchically lower, service clusters may be reviewed at the first directory service utility 716 to determine that a particular remote directory service utility is likely to have a service provider for the service in its registry (step 1008). If a summary indicates that a service provider for the requested service is registered with a remote DSU associated with the summary, a propagated query is sent to the remote DSU (step 1010). If no summaries indicate a service provider for the requested service, a propagated query is sent to the remote DSU of the parent service community (step 1012).

Given the above steps and the network illustrated in FIG. 8, it may be that a query for VoIP service is received at the first DSU 716. As a VoIP service provider is unavailable in the first service community 712, the first DSU 716 will not find a registered service provider in its registry. However, upon reviewing summaries received from DSUs in child service communities, a summary from the second DSU 816 may indicate that a VoIP service provider is available in the remote service community 812. In such a case, the first DSU 716 may send a propagated query to the second DSU 816. Upon receiving the propagated query, the second DSU 816 may then send information identifying the remote VoIP service provider 814 to the local telephone station apparatus 702A.

Alternatively, summaries received from DSUs in child service communities may not indicate any VoIP service providers registered with DSUs. In such a case, the first DSU 716 may send a propagated query to a DSU in its parent service community. The parent service community may be the remote service community 812, in which case the first DSU 716 sends a propagated query to the second DSU 816. Upon receiving the propagated query, the second DSU 816 may then send information identifying the remote VoIP service provider 814 to the local telephone station apparatus 702A.

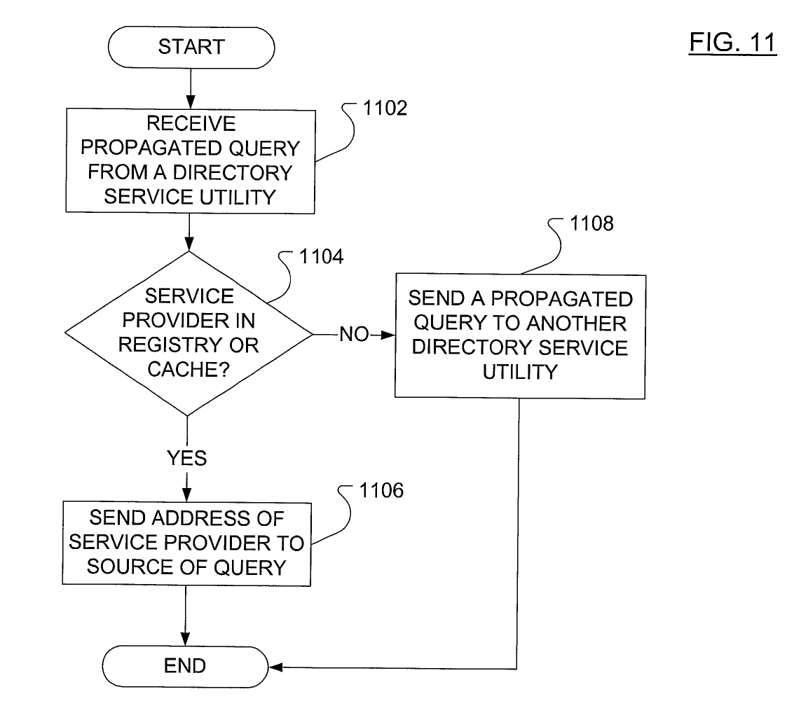

As illustrated by FIG. 11, steps followed by the second directory service utility 816 differ only slightly from those followed by the first directory service utility 716 in FIG. 10. The primary difference is in the receipt of a propagated query (step 1102) rather that the original query (step 1002, FIG. 10). The second directory service utility 816 subsequently consults a registry to find a service provider for the requested service (step 1104). If a service provider is found, as the remote VoIP service provider 814 would be in FIG. 8, the address of remote VoIP service provider 814 is sent to the local telephone station apparatus 702A (step 1106) in a response to the query. If no service providers are found in the registry, the second directory service utility 816 may check its cache and then send the propagated query to another directory service utility (step 1108).

In general, a directory service utility 316 may maintain a registry having multiple registration entries, where each registration entry is associated with a different service. Furthermore, the directory service utility 316 need not restrict the registry to information regarding local service providers 314. The directory service utility 316 may learn information about remote service providers through receipt of summaries from remote directory service utilities through the service information propagation method, described hereinbefore. Information about remote service providers may be maintained in the registry or in the summary as received. The directory service utility 316 can also learn about remote services from the results of previous successful queries. Query results may be cached by the directory service utility 316 (in cache 409, FIG. 4) and can be easily supplied to a user who looks for a network service that has been recently queried by another user.

Use of the cache 409 can improve the performance of a network that employs the present invention in respect of a queries for a frequently used service. Cached service information may include a time stamp and may be removed from the cache 409 when the service information exceeds a predetermined age. Before propagating a query, a DSU can consult the cache 409. On finding the requested service information in the cache 409, the DSU may verify that the service remains available at the remote address contained in the cached service information. If the service is found to be available, the time stamp of the cached item may be updated and the service information sent to the user. Otherwise, the service information may be removed from the cache 409 and the query propagated normally.

The caching feature can be particularly useful in a wireless environment, especially if user specific information, such as frequently used services, is considered to be cacheable data. Currently, wireless service providers maintain a great deal of information specific to each user. With the caching mechanism as described in conjunction with the wireless environment, user specific information can be automatically propagated to a DSU local to the wireless service provider hardware to which a given user connects.

Consider the disclosed architecture in conjunction with a user requiring a video streaming service. The user may have initially requested a video streaming service from a DSU and received information describing a video streaming service provider. Responsive to a request from the user, the video streaming service provider would have provided a video streaming application to the user and streaming video content to be viewed by the user using the video streaming application. Given that such applications typically consume a great deal of bandwidth, the user may wish some Quality of Service (QoS) guarantees for the route through a network that connects the video streaming service provider to the user.

Standard signaling protocols for guaranteeing QoS include the Resource reSerVation Protocol (RSVP) and the Session Initiation Protocol (SIP). The video streaming service provider may have an awareness that the provided service and/or application can take the advantage of a QoS service, if such a service is available in the network. Where a QoS service is available, the video streaming service provider may query the local Directory Service Utility requesting a QoS service. The query for a QoS service may request that, if a QoS service is currently not available, the DSU notify the video streaming service provider when such a service becomes available.

When a QoS service provider makes the service available to the network by registering with the DSU, the DSU may notify the video streaming service provider. The video streaming service provider may then access the QoS service using an application provided by the QoS service. This relieves the video streaming service provider from being tied to any particular protocol or QoS solution. The video streaming service provider can use any QoS solution that becomes available in the network. Notably, the above example illustrates that the present invention is applicable in hardware based network elements such as core routers and switches. Further, service providers may decrease time-to-market by implementing features, such as QoS provision, without necessity for knowledge of the specific protocols used for providing the feature.

In a general distributed computing scenario, a complex computation may be broken into a number of small tasks that can be performed independently by several participating workers. The individual results of each of the tasks may be collected by a master to assemble a complete solution. Through use of the herein disclosed inventive infrastructure, each of the tasks referred to above may be performed by individual service providers. A master may send a query to a DSU for a service corresponding to each task, avail itself of the services provided by each of the service providers contacted in this way and assemble a complete solution. The master is neither required to know details about other capabilities of the participating service providers nor the number of service providers available.

For an illustration of distributed computing according to the present invention, consider a “network calculator”. The network calculator may be used to predict stock prices of several stocks but may not have a stock prediction algorithm built-in. In the non-distributed case, the network calculator may send a query to a local DSU requesting a computation service for stock price prediction. If such service is available, the network calculator may receive an application from the service provider and execute the application in the local environment. However, the local environment may not have enough computing resources such as memory and processor power. In such a case, the network calculator may be implemented using the distributed computing model outlined above.

The prediction of stock prices may be broken into multiple tasks and each task may be mapped to a query that is sent to a DSU. The network calculator may then be contacted by multiple service providers, each able to fulfil the service requested by a respective query. As each service provider provides a respective service to the network calculator, the network calculator collects a result. When all results are collected, the network calculator assembles the results to yield a complete solution. Ideally, this use of distributed computing by a network connected device is automatic, occurring without user intervention.

As will be apparent to a person skilled in the art, the applications in use at the network connected devices and directory service utilities, for performing methods exemplary of this invention, may be written in the Java programming language so that, as is known, once written and compiled, the applications may be run on any network connected device having a Java virtual machine. Clearly, embodiments of the present invention may build upon existing Jini™ network technologies and other distributed computing solutions (e.g., the aforementioned (TSpaces, Service Location Protocol, etc.) to maximize the potential of this solution.

Other modifications will be apparent to those skilled in the art and, therefore, the invention is defined in the claims.

We claim:

1. A method of coordinating access to a data network service comprising:
maintaining a registry of a plurality of service providers;
receiving a query for a requested data network service from a source, said query including required attributes of said requested data network service;
searching said registry to determine whether a given one of said plurality of service providers in said registry can provide said requested data network service having said required attributes; and
if said given one of said plurality of service providers in said registry can provide said requested data network service having said required attributes, sending information identifying said given one of said plurality of service providers to said source of said query.

2. The method of claim 1 further comprising, if none of said plurality of service providers in said registry can provide said requested data network service having said required attributes,
selecting a remote directory service utility; and
sending a propagated query to said remote directory service utility.

3. The method of claim 2 wherein said selecting comprises consulting a summary of services available at said remote directory service utility to determine that said requested data network service is likely to be available from a service provider registered with said remote directory service utility.

4. The method of claim 2 wherein said selecting is based on a hierarchical relationship and said remote directory service utility is hierarchically higher than a directory service utility performing said selecting.

5. The method of claim 1 wherein said query is described using Extensible Markup Language (XML).

6. The method of claim 1 wherein said source of said query is a network connected device requiring said data network service.

7. The method of claim 1 wherein said source of said query is a directory service utility.

8. The method of claim 1 further comprising:
receiving, from a particular service provider, a service description indicating attributes of a provided service; and
adding said particular service provider to said registry.

9. A directory service utility comprising:
a registry of a plurality of service providers;
a processor for searching said registry to determine whether a given one of said plurality of service providers in said registry can provide a requested data network service having required attributes; and
a network interface for:
receiving a query for said data network service having said required attributes from a source; and
sending information identifying said given one of said plurality of service providers to said source of said query.

10. A directory service utility comprising:
means for maintaining a registry of a plurality of service providers;
means for receiving a query for a requested data network service from a source, said query including required attributes of said requested data network service;
means for searching said registry to determine whether a given one of said plurality of service providers in said registry can provide a requested data network service having required attributes; and
means for sending information identifying said given one of said plurality of service providers to said source of said query.

11. A computer readable medium containing computer-executable instructions which, when performed by a processor in a directory service utility, cause the processor to:
maintain a registry of a plurality of service providers;
receive a query for a requested data network service from a source, said query including required attributes of said requested data network service;
search said registry to determine whether a given one of said plurality of service providers in said registry can provide said requested data network service having said required attributes; and
if a given one of said plurality of service providers in said registry can provide a requested data network service having said required attributes, send information identifying said given one of said plurality of service providers to said source of said query.

12. At a first directory service utility situated in a local service cluster, a method of coordinating access to a data network service comprising:
maintaining a registry of a plurality of service providers;
receiving a propagated query for a requested data network service from a second directory service utility situated in a remote service cluster, where said propagated query includes a source of an initial query and required attributes of said requested data network service;
searching said registry to determine whether a given one of said plurality of service providers in said registry can provide said requested data network service having said required attributes; and
if said given one of said plurality of service providers in said registry can provide said requested data network service having said required attributes,
extracting said source of said initial query from said propagated query; and
sending information identifying said given service provider to said source of said initial query.

13. A method of registering a service provider comprising:
receiving a data network address for said service provider
receiving, from said service provider, attributes of a service provided by said service provider, where said attributes are expressed in Extensible Markup Language format; and
adding said service provider to a registry of service providers.

14. The method of claim 13 further comprising:
before said receiving, receiving, from said service provider, a multicast message requiring a directory service utility and indicating attributes of a provided service; and
replying to said message.

15. At a service provider, a method of registering with a directory service utility comprising:
multicasting a message indicating a requirement for a directory service utility;
receiving a reply from a given directory service utility; and
sending a service description to said given directory service utility.

16. The method of claim 15 wherein said service description includes attributes of a service provided by said service provider.

17. The method of claim 16 wherein said attributes include a location of said service provider.

18. A method of building network relationships at a first directory service utility in communication with at least one other directory service utility, said method comprising:
selecting one said directory service utility from said at least one other directory service utility as a selected directory service utility;
assigning said selected directory service utility a parent directory service utility designation; and
indicating said parent directory service utility designation to said selected directory service utility.

19. A method of service information propagation at a first directory service utility comprising:
creating a summary of information about at least one service provider registered with said first directory service utility; and
sending said summary to a second directory service utility.

20. The method of claim 19 wherein said second directory service utility has been designated as a parent directory service utility of said first directory service utility.

21. The method of claim 19 wherein said creating said summary involves bloom filtering.

22. A method of coordinating access to a data network service comprising:
maintaining a registry of a plurality of service providers;
receiving a query for a requested data network service from a source, said query including required attributes of said requested data network service;
searching said registry to determine whether a given one of said plurality of service providers in said registry can provide said requested data network service having said required attributes; and
if none of said plurality of service providers in said registry can provide said requested data network service having said required attributes,
consulting a summary of services available at service providers registered with at least one remote directory service utility;
determining that said requested data network service is available from a service provider registered with a particular remote directory service utility; and
sending a propagated query to said particular remote directory service utility, where said propagated query is based on said query for said requested data network service.
